(19) United States
(12) Patent Application Publication
(10) Pub. No.: US 2010/0082516 A1
(43) Pub. Date: Apr. 1, 2010

(54) Modifying a System in Response to Indications of User Frustration

(75) Inventors: Sumit Basu, Seattle, WA (US); John D. Dunagan, Bellevue, WA (US); Kevin K. Duh, Seattle, WA (US); Kiran-Kumar Muniswamy-Reddy, Somerville, MA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/239,886

(22) Filed: Sep. 29, 2008

(51) Int. Cl. G06N 5/02

(52) U.S. Cl. 706/47; 706/46

(57) ABSTRACT

An illustrative frustration processing system modifies the operation of a target system to improve its performance. In one case, the frustration processing system receives express indications that a user is frustrated in the course of interacting with the target system. The frustration processing system responds to these indications by modifying the operation of the target system to reduce the likelihood that the user will be frustrated in the future. The frustration processing system can modify the operation of the target system by applying a policy to the target system. The policy, in turn, is created using a prediction model. The prediction model predicts when a user is likely to be frustrated based on the user's prior indications of frustration.

### BACKGROUND

Computing systems occasionally exhibit performance that is considered unsatisfactory. For instance, the unsatisfactory performance may manifest itself in slowdowns or “hangs” in the operation of the computer systems. These performance issues may frustrate users, especially if they become pervasive.

These types of problems are typically addressed using a manual approach. For instance, an analyst may attempt to manually derive a performance metric that explains the performance of a system as a function of one or more measurable characteristics of the system, such as memory usage, input-out performance, processor utilization, and so on. The analyst may also attempt to ameliorate performance problems using this metric. For instance, the analyst may manually derive a mechanism which performs a corrective action that is a function of one or more measurable characteristics of the system. These types of solutions are often applied to a multi-user server environment. In such a context, it is possible to amass training data under various conditions; the analyst can manually derive the performance metric based on this data.

The above approach is not always fully satisfactory. First, a system may be complex, including multiple processes, each process associated with multiple characteristics. At any given time, different combinations of processes may be running. It may be very difficult to use theoretical a priori analysis to accurately account for the myriad of ways that such a system may exhibit unsatisfactory performance. Second, there may not be consensus among users as to what constitutes unsatisfactory performance. For instance, different users may use a system in different ways, so that different users may encounter different types of problems. Moreover, different users have different tolerances for different types of system phenomena. As such, a manually derived performance metric may not accurately reflect the performance issues that an individual user finds problematic.

There may be yet other potential drawbacks to the above-described approach to addressing performance problems in a system.

### SUMMARY

An illustrative approach is described for modifying the operation of a target system to improve its performance. In this approach, a frustration processing system receives indications that a user is frustrated in the course of interacting with the target system (e.g., in response to input actions expressly taken by the user). The frustration processing system responds to these indications by modifying the operation of the target system to reduce the likelihood that the user will be frustrated in the future.

According to one illustrative aspect, the frustration processing system includes a prediction module which operates using a prediction model. The prediction model predicts when the user is likely to be frustrated based on the user's prior indications of frustration. The frustration processing system can create the prediction model based on a collection of features that characterize the operation of the target system over a span of time, in combination with a collection of frustration event items associated with the user's indications of prior frustration.

According to another illustrative aspect, the frustration processing system also includes a policy selection module. The policy selection module operates by selecting a policy that is likely to reduce the frustration of the user in the future. In one case, the policy selection module can operate by analyzing a plurality of candidate policies using the prediction model. The prediction model indicates whether each of the candidate policies is likely to reduce the user's frustration in the future. The policy selection module can select the policy that is determined to most appropriately reduce the likelihood of the user's future frustration.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative frustration processing system for reducing a user's frustration in interacting with a target system.

FIG. 2 is a more detailed depiction of the frustration processing system of FIG. 1.

FIG. 3 shows an illustrative implementation of the frustration processing system and the target system (of FIG. 1) using a local system.

FIG. 4 shows an illustrative implementation in which any aspects of the frustration processing system and the target system (of FIG. 1) can be distributed between a local system and a remote system.

FIG. 5 shows an illustrative implementation of the target system of FIG. 1; in this case, the target system implements multiple processes, each process being characterized by one or more features.

FIG. 6 is a graph that shows an illustrative collection of processes that may be performed by the target system as a function of time, particularly showing a merely illustrative collection of processes that are running at the time of a user's indication of frustration.

FIG. 7 shows an illustrative composition of a prediction model and a policy selection module used in the frustration processing system of FIG. 1.

FIG. 8 is an illustrative procedure that provides an overview of one manner of operation of the frustration processing system of FIG. 1.

FIG. 9 is an illustrative procedure that explains one way in which the frustration processing system of FIG. 1 can log frustration event items.

FIG. 10 is an illustrative procedure that explains one way in which the frustration processing system of FIG. 1 can log features that characterize the operation of the target system.

FIG. 11 is an illustrative procedure that explains one way in which the prediction model of FIG. 7 can create or adjust a prediction model based on collected frustration event items and features.

FIG. 12 is an illustrative procedure that provides an overview of how the prediction module and the policy selection module of FIG. 7 can be used to select and apply a policy aimed at reducing the user's frustration.

FIG. 13 shows illustrative processing functionality that can be used to implement any aspect of the features shown in the foregoing drawings.

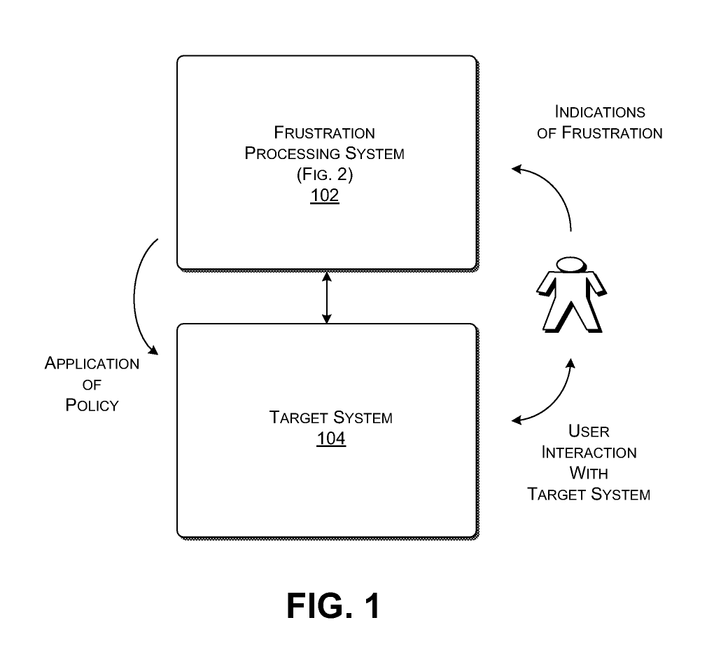

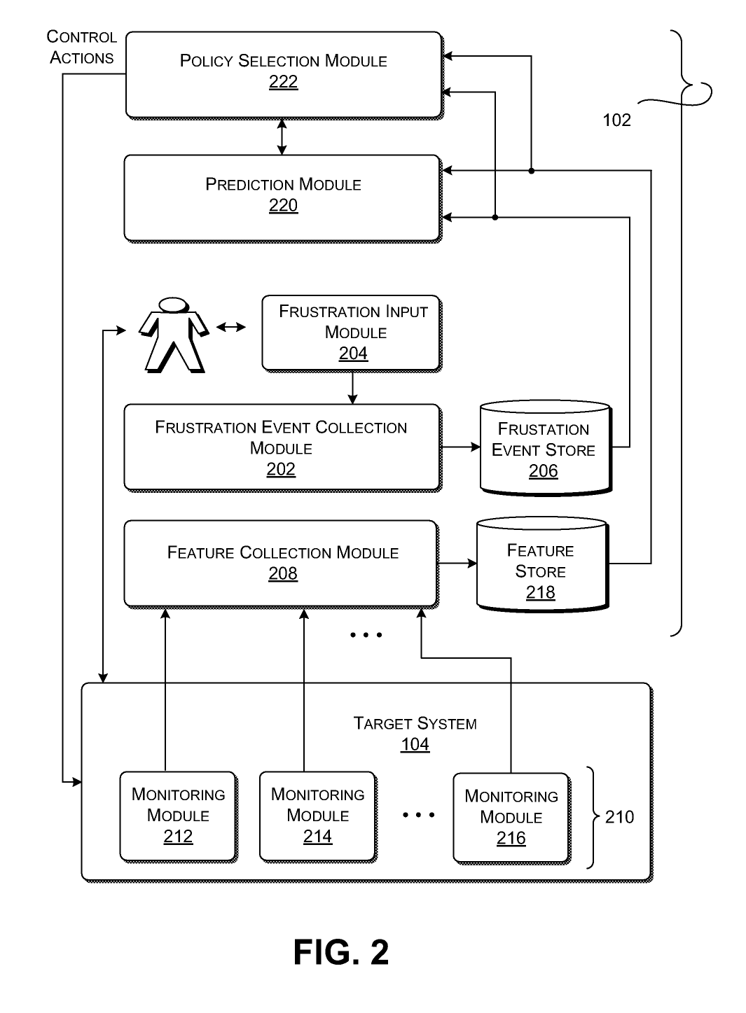

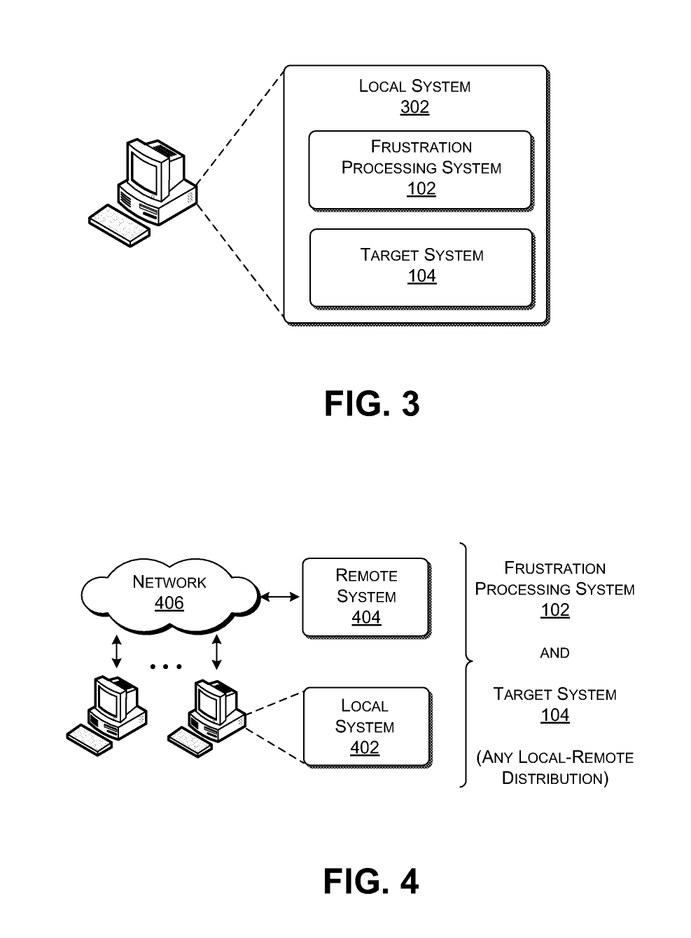

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure sets forth an approach for reducing frustration experienced by a user in the course of interacting with a target system. The approach takes action to reduce the likelihood of future frustration by applying a selected policy to the target system. The selected policy, in turn, is generated based on the user's indication of prior incidents of frustration in interacting with the target system.

The approach may successfully address problems that occur in the operation of even a complex target system that includes multiple processes. This is because the modeling provided by the approach is primarily driven by empirical information regarding prior incidents of unsatisfactory performance, rather than a heuristic or manually derived measure of the user's frustration. Further, the approach may specifically address the problems that an individual user finds frustrating. This is because the approach takes corrective action based on the actual problems identified by the user in the course of interacting with the target system. More generally, the concepts disclosed herein may address one or more of the challenges or problems previously noted, but are not limited to addressing all or any of these challenges or problems.

This disclosure is organized as follows. Section A describes an illustrative system for reducing a user's frustration in interacting with a target system. Section B sets forth illustrative methods that explain the operation of the system of Section A according to one illustrative implementation. Section C describes illustrative processing functionality that can be used to implement any aspect of the features described in Sections A and B.

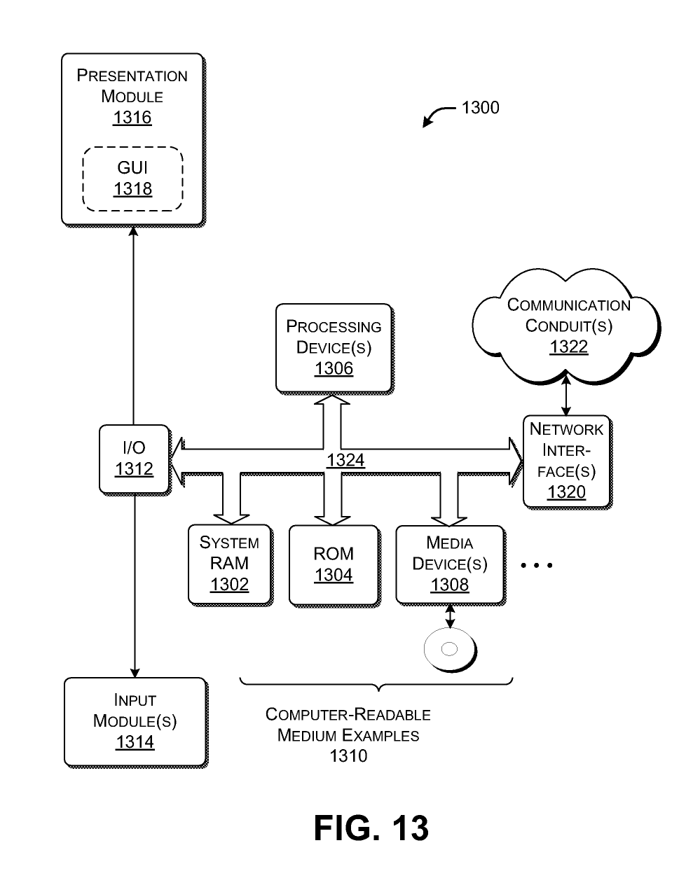

As a preliminary matter, some of the figures describe the concepts in the context of one or more components, variously referred to as functionality, modules, features, elements, etc. The various components shown in the figures can be implemented in any manner, for example, by software, hardware, firmware, manual processing operations, and so on, or any combination of these implementations. In one case, the illustrated separation of various components in the figures into distinct units may reflect the use of corresponding distinct physical components. Alternatively, or in addition, any single component illustrated in the figures may be implemented by plural physical components. Alternatively, or in addition, the depiction of any two or more separate components in the figures may reflect different functions performed by a single physical component. FIG. 13, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of operation). The blocks shown in the flowcharts can be implemented by software, firmware, hardware, manual processing, any combination of these implementations, and so on.

As to terminology, the phase “configured to” encompasses any way that any kind of functionality can be constructed to perform an identified operation. The functionality can be configured to perform an operation using, for instance, hardware, software, firmware, etc., and/or any combination thereof.

The term “logic” encompasses any functionality for performing a task. For instance, each operation illustrated in the flowcharts corresponds to logic for performing that operation. In one case, logic may correspond to computer-readable instructions. In another case, logic may correspond to discrete logic components or a combination of discrete logic components and computer-readable instructions.

A. Illustrative Systems

FIG. 1 shows an illustrative frustration processing system 102 that interacts with a target system 104. These components are shown as distinct entities to facilitate explanation. However, in one case, the resources used by the frustration processing system 102 can overlap with the resources used by the target system 104. For example, in one case, the frustration processing system 102 can be implemented as a module within the target system 104.

By way of broad overview, the frustration processing system 102 operates by receiving a user's indication of frustration in the course of the user's interaction with the target system 104. Based on this information, the frustration processing system 102 devises and applies a policy chosen to reduce future occurrences of frustration.

The target system 104 can correspond to any functionality that performs any operation or combination of operations. In the case most commonly evoked herein, the target system 104 corresponds to an operating system of a computer system, for example a personal computer system. As will be discussed, the operating system may host a plurality of processes, any of which may be running at any given time. But the concepts disclosed herein are not limited to the operating system environment. In another case, for instance, the target system 104 may correspond to an individual application running on a computer system of any nature. Moreover, the concepts disclosed herein are not limited to a personal computer environment. In another case, for instance, the target system 104 may correspond to any functionality implemented on a mobile computing device (e.g., a mobile telephone), a game console, a set-top box, and so on. Further, the concepts disclosed herein are not limited to a local environment. In another case, the target system 104 can be implemented, in whole or in part, by a remote system (as will be discussed below in the context of FIG. 4). Further still, the target system 104 can correspond to a distributed system. Still other implementations of the target system 104 are possible.

The frustration processing system 102 can correspond to any functionality for interacting with the target system 104 to reduce a user's frustration in interacting with the target system 104. As noted above, in one case, the frustration processing system 102 can correspond to a module that is implemented within the target system 104. For example, the frustration processing system 102 can correspond to software, firmware, or hardware (or any combination thereof) that makes use of resources provided by the target system 104. In another case, the frustration processing system 102 can correspond to any functionality that is distinct from the target system 104. For example, the frustration processing system 102 can be implemented as a processing card which couples to the target system 104. Or the frustration processing system 102 can be implemented by a separate computing system which interacts with the target system 104. Still other implementations are possible.

FIG. 2 shows a more detailed illustration of the illustrative frustration processing system 102 and the target system 104. One feature of the frustration processing system 102 is a frustration event collection module 202. The frustration event collection module 202 receives an indication from a user when the user experiences frustration in the course of interacting with the target system 104. In one case, the frustration event collection module 202 receives such an indication in response to a user's express actuation of a frustration input module 204. The frustration event collection module 202 responds by storing a frustration event item in a frustration event store 206. In effect, the frustration event item memorializes the occasion upon which the user experienced frustration in interacting with the target system 104.

The term “user frustration” should be broadly construed as used herein. In general, the frustration of the user is subjectively defined by the user who experiences such frustration. For instance, in a common case, a user may experience frustration when the target system 104 is not responding in a timely manner. That is, the user may experience frustration when the operation of the target system 104 seems to momentarily lock up (“hang”) or slow down. But a user can experience frustration in response to other system behavior. For example, the user may experience frustration if the target system 104 fails to perform a function in a manner that is expected, even though there is no perception that the target system 104 has slowed down or locked up.

In general, the frustration processing system 102 is configured to address those types of frustrations that can be remedied (or reduced) by adjusting the characteristics of the target system 104, e.g., by metaphorically “tuning” the target system 104. A potentially wide class of frustrations can be addressed in this manner, although not all. To facilitate explanation, the following discussion will most often evoke the case in which the user's frustration is associated with a slowdown or hang; but it should be kept in mind that the frustration processing system 102 can address other types of frustrations (attributed to other phenomena exhibited by the target system 104).

In operation, the user can actuate the frustration input module 204 approximately at the same time that he or she experiences frustration. The frustration input module 204 can correspond to any functionality for receiving the user's indication of frustration. In one case, for example, the frustration input module 204 can correspond to an assigned key input mechanism provided on the user's keyboard (not shown) which can be actuated by the user to report his or her frustration. In another case, the frustration input module can correspond to a voice recognition module that receives the user's spoken indication of frustration (such as when, for example, the user speaks the word “frustrated!” upon experiencing frustration). Still other implementations of the frustration input module 204 are possible.

The frustration event collection module 202 can store any type of information which memorializes the user's actuation of the frustration input module 204. As stated above, this information is referred to herein as a frustration event item. A frustration event item can provide timestamp information which indicates the time at which the user actuated the frustration input module 204 (as gleaned, for instance, from a system clock or the like). The frustration event item can also optionally identify information regarding the prevailing characteristics of the target system 104 at the time that the user actuates the frustration input module 204.

Moreover, the frustration event item can also optionally identify user-supplied information. For instance, when the user actuates the frustration input module 204, the frustration event collection module 202 can optionally present any kind of prompt to the user which invites the user to identify the reason (or reasons) why he or she is frustrated. For example, the frustration event collection module 202 can present a pop-up panel on a computer monitor that provides such a prompt. This kind of pop-up panel (not shown) can accept the user's explanation of his or her frustration in free-form text form. Alternatively, or in addition, the pop-up panel can present a list of possible causes of frustration, from which the user may select. Alternatively, or in addition, the frustration event collection module 202 can extract the user's explanation of his or her frustration using an interactive dialogue. Alternatively, or in addition, the frustration event collection module 202 can receive the user's explanation through audible prompts (to convey questions to the user) and voice recognition technology (to receive the user's answers to the prompts). Still further implementations are possible; alternatively, the frustration event collection module 202 can entirely omit the above-described functionality for soliciting an explanation from the user. When used, the user's supplemental input can assist the frustration processing system 102 in effectively addressing the user's frustration.

As another optional aspect, the frustration event collection module 202 can proactively ask the user whether he or she is frustrated. For example, the frustration event collection module 202 may note that the target system 104 appears to be acting in an undesirable manner. This conclusion can be made by comparing the current performance of the target system 104 with its prior performance and identifying whether the present performance is a significant deviation from the prior performance. In addition, or alternatively, the frustration event collection module 202 can reach this conclusion based on the output of a prediction model; as will be described in detail below, the prediction model predicts, based on the prevailing characteristics of the target system 104, whether the user is likely to be frustrated or not. In the case that there is some likelihood of frustration, however determined, the frustration event collection module 202 can present any kind of prompt, such as a pop-up panel, that asks the user if he or she is indeed currently frustrated. If the user is in fact frustrated, the user can respond by actuating the frustration input module 204. Alternatively, if the user is not frustrated, they can ignore the pop-up panel or activate a “No” command or the like. By virtue of this aspect, the frustration event collection module 202 can make use of active learning. The active learning may supplement the insight gained upon the user's independent (unsolicited) activation of the frustration input module 204.

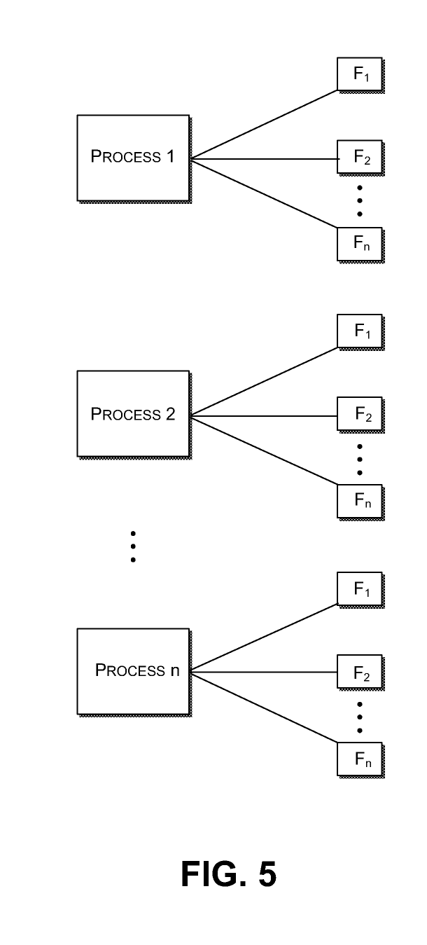

The frustration processing system 102 also includes a feature collection module 208. The feature collection module 208 receives features which characterize the operation of the target system 104. A feature corresponds to any measurable characteristic of the target system 104. For example, a first feature may identify an amount of memory being consumed by the target system 104. Another feature may identify an amount of computing resources being consumed by the target system 104. Another feature may identify the performance of the input/output functionality provided by the system, and so on. No limitation is placed herein on what aspects of the target system 104 may constitute a feature. In one case, to be explained below in the context of FIG. 5, the target system 104 provides multiple processes, any of which can be running at the same time. In this environment, the feature collection module 208 can collect features from the target system 104 on a per-process basis, as well as features about the environment as a whole.

More specifically, the feature collection module 208 can receive features from various monitoring modules 210 provided by the target system 104, such as representative monitoring modules 212, 214, . . . 216. The monitoring modules 210 can correspond to any functionality for recording and forwarding information regarding the performance of the target system 104. In one illustrative and non-limiting case, the monitoring modules 210 can correspond to a collection of performance counters employed by an operating system. These performance counters monitor different aspects of the performance of the operating system (e.g., memory-related characteristics, CPU-related characteristics, input-output-related characteristics, and so on).

The feature collection module 208 can collect the features over a span of time in the course of the operation of the target system 104. In one case, the feature collection module 208 can collect the features at regular intervals of time, such as, in merely one illustrative case, every n seconds. The collected features thereby collectively constitute a profile of the way in which the target system 104 normally operates.

The feature collection module 208 can store the collected features in a feature store 218. Different types of information can be used to represent a feature. In one case, a stored feature can provide information regarding the property of the target system 104 that has been measured, the measured value of the property, the time at which the measurement was made, and so on. For example, an illustrative stored feature can indicate that CPU utilization for process X was Y percent at time Z.

The frustration processing system 102 performs the core of its analysis using a prediction module 220 and policy selection module 222. Addressing the prediction module 220 first, this module 222 creates and applies a prediction model. The prediction model predicts whether or not the user is likely to be frustrated as a function of the actual or hypothetical circumstances prevailing in the target system 104 at any given time. To derive such a model, the prediction module 220 receives the frustration event items from the frustration event store 206 and the features from the feature store 218. The prediction module 220 then identifies the features that were recorded approximately concurrently with the user's prior actuations of the frustration input module 204. This can be gleaned by matching the timestamp information associated with frustration event items with timestamp information associated with the recorded features. (Alternatively, or in addition, the frustration event items themselves can provide all information regarding the features exhibited by the system during the user's prior actuations of the frustration input module 204.) The prediction module 220 then identifies combinations or sets of features that seem to be correlated with user frustration events. The prediction module 220 forms a prediction model which describes these relationships.

The prediction module 220 can gain additional insight into the occurrence of frustration events based on analysis of the features per se over a span of time. For example, the prediction module 220 may note that a particular process typically consumes no more that X % of system memory, but at a particular point in time, it is consuming Y % of memory, where Y is significantly larger than X. This observation is particularly pertinent if the increase in memory consumption coincides with a user-specified frustration event.

In other cases, the prediction module 220 can determine that certain sequences of occurrences in the target system 104 are correlated with frustration events. For example, the prediction module 220 can determine that certain trends in features appear to terminate in frustration events. As such, the prediction module 220 may take system history in account in making its decision as to whether or not the user is likely to be frustrated (for instance, by taking into account a set of features exhibited by the target system 104). Generally stated, the prediction model maps any information that characterizes the operation of the target system 104 at any given point in time to an indication of whether or not the user is likely to be frustrated.

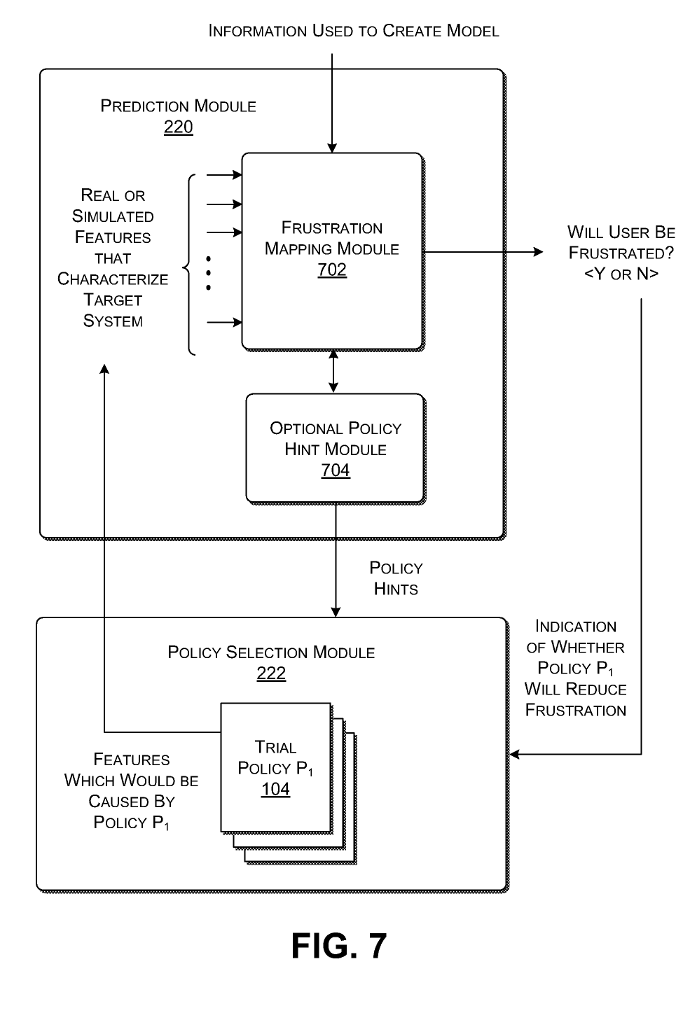

After its formation, the prediction model can be used to predict the user's future frustration by inputting a hypothetical or actual set of experienced features. In some cases, such a set of features may take system history into account; but to facilitate explanation, the remaining discussion assumes that the prediction model does not take system history into account (such that the prediction model bases it decision on just the prevailing set of features exhibited by the target system 104). In one implementation, the prediction model maps this input to a binary decision of whether or not the user is likely to be frustrated (although the output of the prediction model can also be a variable which reflects a continuous range of confidence values). Additional details regarding the construction and operation of the prediction module 220 will be provided in the context of the discussion of FIG. 7 below.

The policy selection module 222 operates by identifying a policy that may reduce incidents of user frustration in the future. Again, a full explanation of the construction and operation of this module 222 is set forth in the context of the discussion of FIG. 7 below. By way of overview, a policy identifies one or more control actions that may be taken to modify the behavior of the target system 104. For example, a policy may provide an instruction to change the memory consumption of any operation performed by the target system 104, change the allocated processor usage of any operation, change the priorities of any operation (vis-à-vis other operations), and so on. No limitation is placed herein on what may constitute a control action. Prior to application of a policy, the policy selection module 222 can identify the features of the target system 104 that will be exhibited upon the invocation of the policy. For example, consider a policy that provides an instruction to reduce a process's processor consumption to no more than 10% of total processor capacity. When implemented, this policy (if successful) will lead to a measured feature that indicates that the processor consumption of the process is in fact no more than 10%.

In one case, the policy selection module 222 can make use of the prediction module 220 in selecting appropriate policies. For example, the policy selection module 222 can present a hypothetical “question” to the prediction module 220: If policy X is presented to the target system 104, will this action likely reduce the user's future levels of frustration? The prediction module 220 can process this request by identifying the features that will be caused (or manifested) by the policy. The prediction module 220 can then map these features to a binary (or variable) indication of whether the user is likely to be frustrated upon application of the policy. The prediction module 220 can report its answer back to the policy selection module 222. If the answer is negative (namely, indicating that the user will continue to be frustrated upon the application of the proposed policy), the policy selection module 222 can propose another policy to the prediction module 220.

Upon finding a policy that is likely to reduce user frustration, the policy selection module 222 can apply this policy to the target system 104. This policy will, in fact, either reduce the level of the user's frustration in the future, or fail to reduce frustration. If the policy is not providing satisfactory results, this will be conveyed by newly acquired frustration event items, as the user continues to signal his or her dissatisfaction with the target system 104. In this case, the prediction module 220 and the policy selection module 222 can update their models based on the information gleaned from a new collection of frustration event items and associated system features.

The timing at which the frustration processing system 102 can take the above-described corrective action is environment-specific. In one scenario, the frustration processing system 102 can take corrective action once it has collected enough information (frustration event items and features) to arrive at a corrective policy that is predicted to reduce user frustration with a sufficient degree of confidence. In addition, or alternatively, the user may explicitly control the timing at which such corrective action is taken, such as by activating an “update system parameters” option in the target system 104.

The corrective action that is taken can itself take different forms depending on the nature of the target system 104 that is involved. In one case, the target system may include various tuning mechanisms that modify the behavior of the target system 104. This is the case, for instance, if the target system 104 represents an operating system. The policy selection module 222 can implement the selected policy by adjusting appropriate tuning mechanisms, which can have the effect of adjusting appropriate features of the target system 104 (e.g., memory usage, processor usage, input-output characteristics, and so on).

Two properties of the frustration processing system 102 warrant mention at this time. First, note that the prediction module 220 and the policy selection module 222 model the performance of the target system 104 without using heuristics or preconceived rules (or with reduced reliance on such factors). That is, in one implementation, the prediction module 220 and the policy selection module 222 automatically determine actions that are likely to reduce frustration based on empirical data (namely, the collected frustration event items and features). No a priori model drives this operation; the actions taken by the prediction module 220 and the policy selection module 222 “fall out” based on the collected empirical data and the frustration model learned from this data. Second, note that the prediction module 220 and the policy selection module 222 propose corrective action which is specifically tailored to address the phenomena that an individual user finds unsatisfactory. This is because the models used by the prediction module 220 and the policy selection module 222 are ultimately based on the user's own prior indications of frustration.

Advancing to FIGS. 3 and 4, these figures show two implementations of the frustration processing system 102 and target system 104 shown in FIG. 2. In FIG. 3, both the frustration processing system 102 and the target system 104 are implemented by a local system 302. The local system 302 may correspond to the functionality provided by a computing system of any type, such as a personal computer, a mobile computing device (e.g., a mobile telephone), a game console, a set-top box, and so forth. In one example, the target system 104 may correspond to an operating system implemented by the local system 302, and the frustration processing system 102 can correspond to functionality that is also implemented by the local system 302. As noted before, the frustration processing system 102 can be implemented as a module within the target system 104 itself. Or the frustration processing system 102 can be implemented as a separate entity. Or the frustration processing system 102 can share resources with the target system 104, but the frustration processing system 102 and the target system 104 are otherwise distinct entities, and so on.

FIG. 4 shows a case in which a local system 402 interacts with a remote system 404 via a network 406, such as a wide area network (e.g., the Internet). In one example, the local system 402 can correspond to any kind of user computing system, while the remote system 404 can correspond to any type of server-type computing system (e.g., providing one or more server-type computing devices, one or more data stores, and other data processing equipment). In this case, the frustration processing system 102 and the target system 104 can be distributed in any manner. In one scenario, a user may use the local system 402 to interact with the target system 104 that is implemented by the remote system 404 or by both the local system 402 and remote system 404 in distributed fashion; in this case, the frustration processing system 102 can be implemented by either the local system 402 or the remote system, or in distributed fashion by both the local system 402 and the remote system 404. In another scenario, a user may use the local system 402 to interact with the target system 104 that is implemented entirely by the local system 402; in this case, the frustration processing system 102 can be implemented by the remote system 404, or by a combination of the local system 402 and the remote system 404.

In both FIGS. 3 and 4, the frustration processing system 102 can operate in the manner described above by recording a user's indications of frustrations and then making changes to the target system 104 on a per-user basis. The changes that are made reflect the prior behavior of that particular user in registering his or her frustration.

In another implementation, the frustration processing system 102 can pool the frustration processing events associated with plural users. The frustration processing system 102 can then derive models that reflect the frustration processing events identified by those users (instead of a single user). There are potential advantages to this approach. As one potential advantage, the frustration processing system 102 can potentially derive a more robust understanding of the phenomena that users find frustrating by taking multi-user data into account; it can also potentially derive a more robust understanding of corrective actions which are likely to address the users' frustration by taking multi-user data into account. Further, the frustration processing system 102 can potentially derive its models more quickly by taking multi-user data into account.

However, the use of multi-user frustration event items may reduce the frustration processing system's 102 ability to propose policies which are specifically tailored to the needs of a particular user. This is because the corrective actions no longer reflect the frustration-related behavior of a single user. The frustration processing system 102 can partly ameliorate the lack of customization in operation by identifying groups of users who may share similar traits. Any characteristics or combination of characteristics can be used to identify groups of similar users. The frustration processing system 102 can then collect and organize the frustration event items on a group-by-group basis and also apply corrective policies on a per-group basis. The reasoning which underlies this strategy is that groups of similar users may exhibit similar frustration-related behavior.

In yet another scenario, the frustration processing system 102 can derive policies for a user which reflect a combination of the user's own frustration-related behavior and global frustration-related behavior (associated with plural users). For example, the frustration processing system 102 can derive policies based on a combination of user-specific frustration event items and global frustration event items. This combination is particularly appropriate in those cases in which the individual user's behavior is idiosyncratic with respect to the global behavior. The user may manually select the relative weight to be given to his or her own behavior relative to the global frustration-related behavior.

In addition, or alternatively, the frustration processing system 102 can automatically adjust the weights to be given to local and global frustration-related behavior. For instance, the frustration processing system 102 can apply policies that derive from global frustration-related behavior until that time at which an individual user has identified enough frustration events to establish a policy that is specifically tailored for that user. Or the frustration processing system 102 can automatically adjust the weights given to global and user-specific behavior in a more gradual manner. Still other ways of combining local and global considerations are possible.

In any of the cases described herein, a user may be given a choice to opt in or opt out of the collection of frustration-related behavior. Of course, the user may de facto opt out of the collection of his or behavior by refusing to actuate the frustration input module 204 when frustrated. In those cases in which behavior is collected, the frustration processing system 102 can provide appropriate safeguards to maintain the privacy of the collected information. Further, the frustration processing system 102 can allow the user to access the information that has been collected to make corrections to the information or delete or disable it in its entirety.

In another scenario, one or more users' frustration event items can be used to adjust parameters of a distributed system, e.g., a system whose components are spread out over multiple machines or other processing components. For example, the frustration processing system 102 can be used to adjust the performance of a data center or the like that includes plural server-type computers, etc.

FIG. 5 shows an overview of the functions performed by one illustrative target system 104. In this case, the target system 104 may implement multiple processes (e.g., process 1, process 2, etc.). The processes may correspond to any functions performed by the target system 104. More generally, a process can correspond to any functionality (or entity), however defined, that can be made the target of a policy. For instance, a process can correspond to any functionality (or entity) that a policy can prioritize or de-prioritize with respect to other process(es). Each process can be characterized by one or more features (e.g., F₁, F₂, etc.) The features may correspond to any measurable property or characteristic of a process. For example, a feature may identify the amount of memory that a process consumes. Another feature may identify the amount of processor resources that has been allotted to a process, and so on.

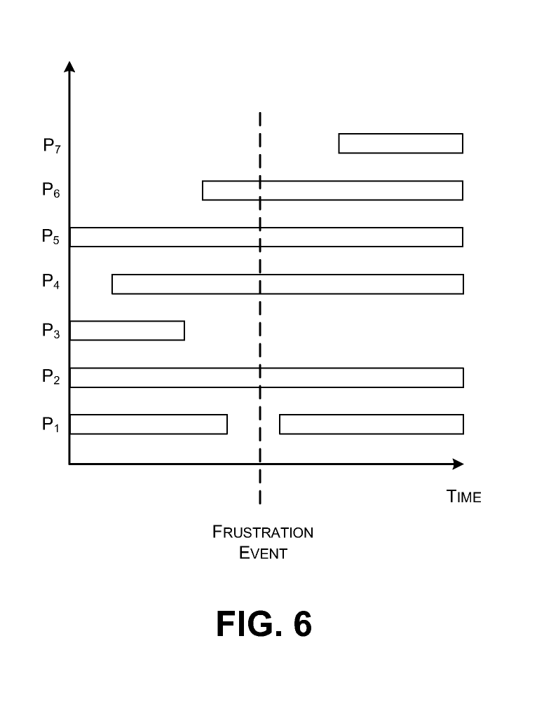

FIG. 6 graphically illustrates that the target system 104 can implement any collection of processes at the same time. For example, at the time that the user actuates the frustration input module 204, one hypothetical target system 104 is running processes P2, P4, P5, and P6. The fact that the user is frustrated can be attributed to any of these processes, or perhaps may be attributed to a unique combination of these processes, and/or other considerations (including, potentially, historical considerations). As can be appreciated, because of the complexity of this target system 104, it may be difficult to derive an a priori theoretical understanding of the underlying cause of unsatisfactory performance. In the approach described herein, the policy selection module 222 can propose a policy which is derived from the frustration event items identified by the user and the features logged by the feature collection module 208, without requiring that an analyst articulate an explanation of what is causing the poor performance.

FIG. 7 shows additional illustrative details regarding the prediction module 220 and the policy selection module 222. Starting with the prediction module 220, this module includes a frustration mapping module 702 which receives a collection of frustration event items which reflect incidents in which a particular user is frustrated in the course of interacting with the target system 104. The frustration mapping module 702 can also receive features which characterize the operation of the target system 104 over a span of time, e.g., collected on a periodic basis. Based on this information, the frustration mapping module 702 generates a prediction model. The prediction model maps a set of features to an indication of whether these features are likely to frustrate a particular user. The set of features may correspond to a hypothetical state of the target system 104 at a particular point in time. Or the set of features may correspond to an actual measured state of the target system 104.

The frustration mapping module 702 can derive the prediction model in various ways. Generally, the frustration mapping module 702 can identify the features that accompany incidents of user frustration. The frustration mapping module 702 can then identify statistically significant patterns in such data. These patterns correlate the presence of certain features with incidents of user frustration. The frustration mapping module 702 can use various techniques to identify such patterns, such as any kind of statistical/machine learning technique, including Bayesian networks, support vector machines, logistic regression, decision trees, neural network techniques, rule induction, first-order logic, and so on. As mentioned above, the frustration mapping module 702 can also analyze the features per se to identify instances in which the features deviate from their normal respective behavior. The frustration mapping module 702 can use the results of this per se analysis to help identify occasions in which a user is likely to express frustration.

The policy selection module 222 selects a policy that is likely to reduce the frustration of the user in the future. To this end, the policy selection module 222 can use the prediction module 220 for the purpose of testing candidate policies prior to their actual implementation. More specifically, the policy selection module 222 can identify one or more features that would be manifested upon application of a candidate policy. The policy selection module 222 can then pass a set of features that is associated with the candidate policy to the prediction module 220; the prediction module 220 can then use the frustration mapping module 702 to determine whether the candidate policy is likely to reduce user frustration, e.g., by inputting the identified set of features into the frustration mapping module 702 and then noting whether the output of the frustration mapping module 702 indicates whether the user is likely to be frustrated or not. If the policy will not likely reduce user frustration, the policy selection module 222 can propose another candidate policy. This procedure is repeated until the prediction module 220 identifies a satisfactory policy. It is also possible to test candidate policies in parallel.

The policy selection module 222 can use various strategies in proposing policies to the prediction module 220. In one case, the policy selection module 222 can sequence through a set of possible policies in an arbitrary manner. In another case, the policy selection module 222 can receive hints from the prediction module 220 (or from some other module) concerning one or more policies that might be successful in reducing user frustration. The policy selection module 222 can then investigate these policies first, e.g., by submitting these policies to the prediction module 220 for testing.

More specifically, the prediction module 220 (or some other module) can include an optional policy hint module 704. The policy hint module 704 provides the above-mentioned hints to the policy selection module 222. The policy hint module 704 can identify such hints in various ways. In one case, the policy hint module 704 can provide a model which ranks the top n features that are likely to be the cause of the user's frustration. It can perform this task by identifying the features associated with a collection of related frustration events. It can then identify whether these features are anomalous (based on a historical indication of the normal behavior of such features). Upon identifying a suspected feature (or features), the policy hint module 704 can formulate a hint which informs the policy selection module 222 of the suspected feature (or features). The policy selection module 222 can use the hint by generating a policy which adjusts the value (or values) of the problematic feature (or features) or which takes some other action having some nexus to the identified feature (or features). Still other ways of providing hints to the policy selection module 222 are possible.

B. Illustrative Processes

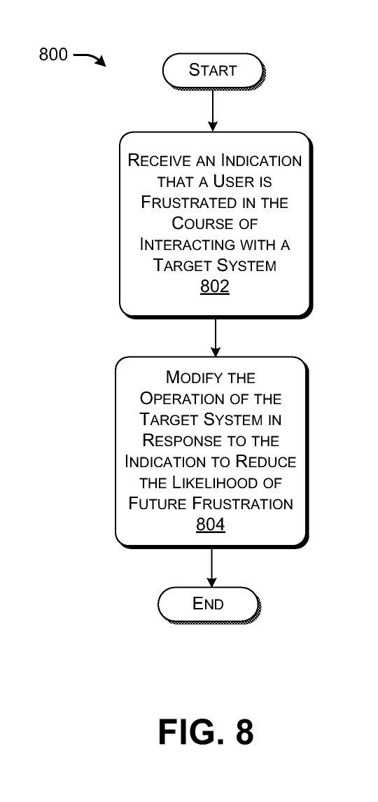

FIGS. 8-12 describe the operation of frustration processing system 102 in flowchart form. Since the principles underlying the operation of the frustration processing system 102 have already been described in Section A, this section will serve as a summary of the operation of the frustration processing system 102.

FIG. 8 shows a procedure 800 which provides an overview of the frustration processing system 102 of FIG. 1.

In block 802, the frustration processing system 102 receives an indication that the user is frustrated. The frustration processing system 102 may receive such an indication in response to the user's express activation of the frustration input module 204.

In block 804, the frustration processing system 102 applies the user's indication of frustration to modify the operation of the target system 804 to reduce the likelihood that the user will be frustrated in the future. In actual practice, block 804 involves taking corrective action (e.g., selecting and applying a policy) after the user identifies a sufficient number of frustration events to enable the frustration processing system 102 to derive sufficiently reliable models.

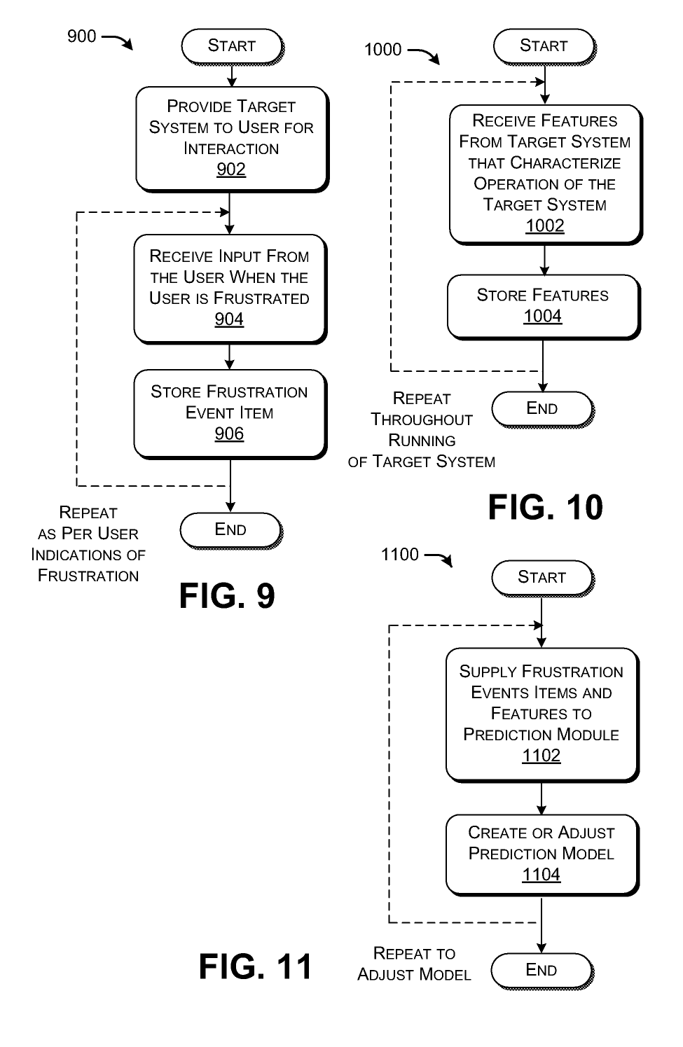

FIG. 9 shows a procedure 900 which explains how frustration event items are stored by the frustration processing system 102.

In block 902, the user interacts with the target system 104. The target system 104 may include multiple processes, and each process may be characterized by one or more features.

In block 904, the frustration processing system 102 receives input from the user which indicates that the user is frustrated. The user can provide such input in unsolicited fashion; alternatively, or in addition, the frustration processing system 102 can prompt the user at various times to determine whether the user is frustrated.

In block 906, the frustration processing system 102 stores a frustration event item that is associated with the user's indication of frustration.

FIG. 10 shows a procedure 1000 which explains how features are stored by the frustration processing system 102.

In block 1002, the frustration processing system 102 receives features from the monitoring modules 210 of the target system 104.

In block 1004, the frustration processing system 102 stores the collected features.

FIG. 11 shows a procedure 1100 which explains how the frustration processing system 102 derives a prediction model.

In block 1102, the frustration processing system 102 receives the frustration event items (collected as per procedure 900) and the features (collected as per procedure 1000).

In block 1104, the frustration processing system 102 creates a prediction model which models the user's frustration-related behavior. Or block 1104 may entail updating (e.g., adjusting) a previously created prediction model based on newly acquired frustration event items and features.

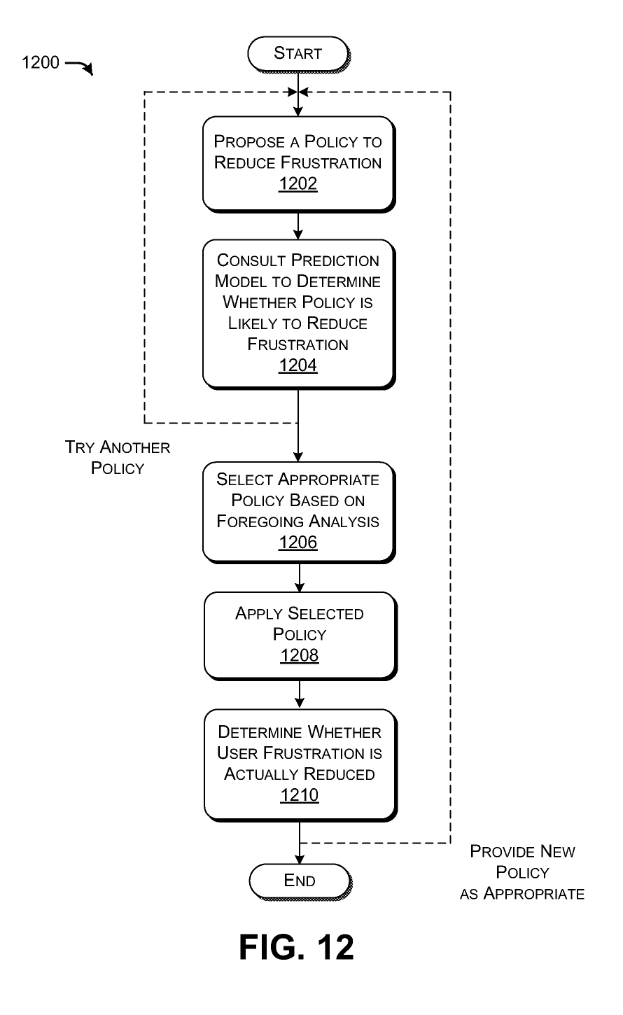

FIG. 12 shows a procedure 1200 which explains how the frustration processing system 102 applies policies to reduce the likelihood of future user frustration.

In block 1202, the policy selection module 222 proposes a policy that may reduce the user's frustration. The policy selection module 222 can make such a proposal in an arbitrary manner, or in response to a hint provided by the policy hint module 704.

In block 1204, the prediction module 220 is called upon to determine whether the hypothetical policy (proposed in block 1202) is likely to reduce the user's frustration in the future. Blocks 1202 and 1204 can be repeated until a policy is identified which is satisfactory (in terms of its likelihood to reduce user frustration). At this point, the frustration processing system 102 has not actually implemented any of the proposed policies; rather, it is “trying out” proposed policies using the services of the prediction module 220.

In blocks 1206 and 1208, the policy selection module 222 selects and applies an identified policy.

In block 1210, the frustration processing system 102 determines, subsequent to the application of the new policy, whether the user's frustration has actually been reduced. The actual success of the policy is determined by observing whether the user continues to indicate that he or she is frustrated, or more specifically, if certain types of frustrations that the frustration processing system 102 has attempted to reduce continue unabated. For example, assume that the user indicates that she is frustrated every time she opens her word processing program. Block 1210 determines whether the user continues to be frustrated upon the opening of this program. If the policy is unsuccessful, then, when next invoked, the policy selection module 222 can propose another policy.

C. Representative Processing Functionality

FIG. 13 sets forth illustrative electronic processing functionality 1300 (or simply “processing functionality” 1300) that can be used to implement any aspect of the functions described above. With reference to FIG. 1, for instance, the type of processing functionality 1300 shown in FIG. 13 can be used to implement any aspect of the frustration processing system 102 and the target system 104.

The processing functionality 1300 can include volatile and non-volatile memory, such as RAM 1302 and ROM 1304, as well as one or more processing devices 1306. The processing functionality 1300 also optionally includes various media devices 1308, such as a hard disk module, an optical disk module, and so forth. The processing functionality 1300 can perform various operations identified above when the processing device(s) 1306 executes instructions that are maintained by memory (e.g., RAM 1302, ROM 1304, or elsewhere). More generally, instructions and other information can be stored on any computer-readable medium 1310, including, but not limited to, static memory storage devices, magnetic storage devices, optical storage devices, and so on. The term “computer-readable medium” also encompasses plural storage devices. The term computer-readable medium also encompasses signals transmitted from a first location to a second location, e.g., via wire, cable, wireless transmission, etc.

The processing functionality 1300 also includes an input/output module 1312 for receiving various inputs from a user (via input modules 1314), and for providing various outputs to the user (via output modules). One particular output mechanism may include a presentation module 1316 and an associated graphical user interface (GUI) 1318. The processing functionality 1300 can also include one or more network interfaces 1320 for exchanging data with other devices via one or more communication conduits 1322. One or more communication buses 1324 communicatively couple the above-described components together.

In closing, the description may have described various concepts in the context of illustrative challenges or problems. This manner of explication does not constitute an admission that others have appreciated and/or articulated the challenges or problems in the manner specified herein.

More generally, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for modifying operation of a target system using electronic data processing functionality, comprising:
receiving an indication that a user is frustrated as the user interacts with the target system; and
modifying the operation of the target system in response to said receiving of the indication, so as to reduce a likelihood of future user frustration.

2. The method of claim 1, wherein said receiving of the indication comprises receiving an input from the user when the user is frustrated.

3. The method of claim 2, further comprising storing a frustration event item in response to the user's input.

4. The method of claim 3, further comprising storing features that characterize operation of the target system over a span of time.

5. The method of claim 4, further comprising creating a prediction model based on a collection of stored frustration event items and stored features, wherein the prediction model predicts whether the user will be frustrated or not as a function of a set of features that characterize actual or hypothetical operation of the target system.

6. The method of claim 5, wherein said modifying of the operation of the target system comprises:
using the prediction model to determine a policy that is likely to reduce the future frustration of the user; and
applying the policy to the target system.

7. The method of claim 6, wherein the policy is determined by analyzing a plurality of candidate policies using the prediction model and selecting a policy that is determined to most appropriately reduce the future frustration of the user.

8. The method of claim 6, further comprising assessing whether the policy that has been applied actually reduces the future frustration of the user, and, if the policy does not reduce the future frustration of the user, determining and applying another policy.

9. A computer-readable medium for storing computer-readable instructions, the computer-readable instructions providing a frustration processing system when executed by one or more processing devices, the computer-readable instructions comprising:
logic configured to store features that characterize operation of the target system over a span of time;
logic configured to store a plurality of frustration event items, each frustration event item associated with a receipt of an input from a user that indicates that the user is frustrated as the user interacts with the target system;
logic configured to create a prediction model based on the stored frustration event items and the stored features, wherein the prediction model predicts whether the user will be frustrated or not as a function of a set of features that characterize actual or hypothetical operation of the target system;
logic configured to determine a policy using the prediction model that is likely to reduce future frustration of the user; and
logic configured to apply the policy to the target system to modify operation of the target system in a manner specified by the policy.

10. The computer readable medium of claim 9, wherein said logic configured to determine the policy is configured to determine the policy by analyzing a plurality of candidate policies using the prediction model and selecting a policy that is determined to most appropriately reduce the future frustration of the user.

11. A frustration processing system for modifying operation of a target system, comprising:
a prediction module configured to apply a prediction model, the prediction model being configured to predict whether the user will be frustrated or not as a function of a set of features that characterize actual or hypothetical operation of the target system; and
a policy selection module configured to use the prediction model to determine a policy that is likely to reduce future frustration of the user.

12. The frustration processing system of claim 11, wherein the target system is an operating system implemented by a local computing system.

13. The frustration processing system of claim 11, wherein at least part of the target system is a network-accessible resource.

14. The frustration processing system of claim 11, further comprising:
a frustration event collection module configured to collect frustration event items, each frustration event item associated with receipt of an input from a user that indicates that the user is frustrated as the user interacts with the target system; and
a feature collection module configured to collect features that characterize operation of the target system over a span of time,
wherein the prediction model is based on the collected frustration event items and the collected features.

15. The frustration processing system of claim 14, wherein the feature collection module is configured to collect features from a plurality of monitoring modules that monitor different performance aspects of the target system.

16. The frustration processing system of claim 14, wherein the feature collection module is configured to collect features associated with a plurality of processes being performed by the target system, each process being associated with one or more features.

17. The frustration processing system of claim 11, wherein the policy selection module is configured to determine the policy by analyzing a plurality of candidate policies using the prediction model and selecting a policy that is determined to most appropriately reduce the future frustration of the user.

18. The frustration processing system of claim 11, wherein the prediction module includes a policy hint module configured to provide a suggestion to the policy selection module for use by the policy selection module in selecting an appropriate policy.

19. The frustration processing system of claim 11, wherein the policy that is determined by the policy selection module is based on frustration event items associated with frustration experienced by a single user as the single user interacts with the target system.

20. The frustration processing system of claim 11, wherein the policy that is determined by the policy selection module is, at least in part, based on frustration event items associated with frustration experienced by plural users as the users interact with the target system.
